(19) United States
(12) Patent Application Publication
(10) Pub. No.: US 2014/0320072 A1
(43) Pub. Date: Oct. 30, 2014

(54) TIME ADJUSTING CHARGE CIRCUIT

(71) Applicants: HONG FU JIN PERCISION INDUSTRY (ShenZhen) CO., LTD, Shenzhen (CN); HON HAI PRECISION INDUSTRY CO., LTD., New Taipei (TW)

(72) Inventors: GUANG-DONG YUAN, Shenzhen (CN); CHUNG-CHI HUANG, New Taipei (TW); ZHONG-PING YANG, Shenzhen (CN); HAI-QING ZHOU, Shenzhen (CN)

(73) Assignees: HONG FU JIN PERCISION INDUSTRY (ShenZhen) CO., LTD, Shenzhen (CN); HON HAI PRECISION INDUSTRY CO., LTD., New Taipei (TW)

(21) Appl. No.: 14/258,232

(22) Filed: Apr. 22, 2014

(30) Foreign Application Priority Data
Apr. 29, 2013 (CN) 2013101550413

(51) Int. Cl. H02J 7/04

(52) U.S. Cl. CPC H02J 7/041; H02J 7/0052
USPC 320/107

(57) ABSTRACT

A charge circuit for charging a battery includes a converter and a timer. The converter converts alternating current (AC) of an AC power supply into direct current (DC) and outputs a DC voltage to the battery through a first resistor. The timer is used to set a period of time and stop charging the battery after the set period of time.

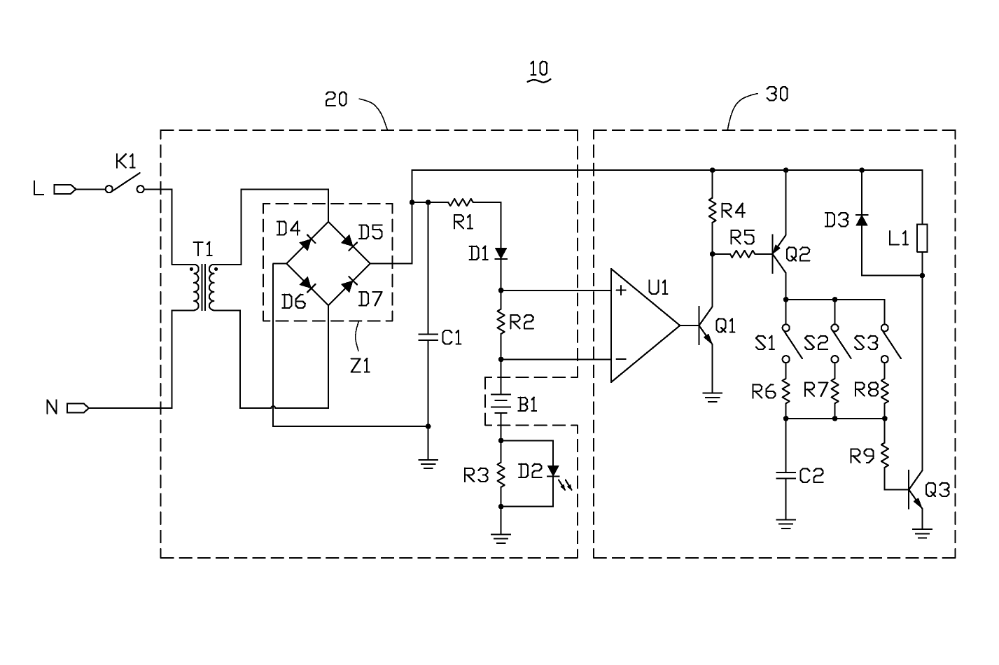

### FIELD

The present disclosure relates to a charge circuit.

### BACKGROUND

Typically, a charge circuit will continue charging a battery even when the battery is full. That can damage the battery.

Therefore, there is room for improvement in the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure. Moreover, in the drawing, like reference numerals designate corresponding parts throughout the several views.

The FIGURE is a circuit diagram of an embodiment of a charge circuit of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

The FIGURE shows an embodiment of a charge circuit 10 of the present disclosure.

The charge circuit 10 comprises a converter 20 and a timer 30.

The converter 20 comprises a voltage transformer T1, a bridge rectification circuit Z1, resistors R1-R3, a capacitor C1, a diode D1, and a light emitting diode (LED) D2. The converter 20 is connected with an alternating current (AC) power supply and converts AC into direct current (DC) for an electronic device, such as a battery B1. A first input terminal of the voltage transformer T1 is connected to a fire terminal L of a live wire of the AC power supply. A second input terminal of the voltage transformer T1 is connected to a zero terminal N of a neutral wire of the AC power supply. The bridge rectification circuit Z1 comprises diodes D4-D7. A cathode of the diode D4 is connected to an anode of the diode D5. A node between the cathode of the diode D4 and the anode of the diode D5 is connected to a first output terminal of the voltage transformer T1. An anode of the diode D4 is connected to an anode of the diode D6. A node between the anode of the diode D4 and the anode of the diode D6 is grounded. A cathode of the diode D5 is connected to a cathode of the diode D7. A node between the cathode of the diode D5 and the cathode of the diode D7 is grounded through the capacitor C1. A cathode of the diode D6 is connected to an anode of the diode D7. A node between the cathode of the diode D6 and the anode of the diode D7 is connected to a second output terminal of the voltage transformer T1. The node between the cathode of the diode D5 and the cathode of the diode D7 is connected to an anode of the diode D1 through the resistor R1. A cathode of the diode D1 is connected to an anode of the battery B1. A cathode of the battery B1 is grounded through the resistor R3. The LED D2 and the resistor R3 are connected in parallel. An anode of the LED D2 is connected to the cathode of the battery B1. A cathode of the LED D2 is grounded.

The timer 30 comprises an operational amplifier U1, electronic switches Q1-Q3, switches S1-S3, resistors R4-R9, a capacitor C2, a diode D3, and a relay. The relay comprises a coil L1 and a dynamic type break contact K1. The dynamic type break contact K1 is connected between the fire terminal of the AC power supply and the first terminal of the voltage transformer T1. A non-inverting input of the operational amplifier U1 is connected to the cathode of the diode D1. An inverting input of the operational amplifier U1 is connected to the anode of the battery B1. An output of the operational amplifier U1 is connected to a first terminal of the electronic switch Q1. A second terminal of the electronic switch Q1 is connected to a first terminal of the electronic switch Q2 through the resistor R5. The second terminal of the electronic switch Q1 is connected to the node between the cathode of the diode D5 and the cathode of the diode D7 through the resistor R4. A second terminal of the electronic switch Q2 is connected to the node between the cathode of the diode D5 and the cathode of the diode D7. A third terminal of the electronic switch Q2 is connected to first terminals of the switches S1-S3. Second terminals of the switches S1-S3 are connected to a first terminal of the capacitor C2 through the resistors R6-R8, respectively. A second terminal of the capacitor C2 is grounded. The first terminal of the capacitor C2 is connected to a first terminal of the electronic switch Q3 through the resistor R9. A second terminal of the electronic switch Q3 is connected to the node between the cathode of the diode D5 and the cathode of the diode D7 through the coil L1. The coil L1 and the diode D3 are connected in parallel. An anode of the diode D3 is connected to the second terminal of the electronic switch Q3. A cathode of the diode D3 is connected to the node between the cathode of the diode D5 and the cathode of the diode D7. A third terminal of the electronic switch Q3 is grounded.

The bridge rectification circuit Z1 outputs a DC voltage through the node between the cathode of the diode D5 and the cathode of the diode D7. The DC voltage charges the battery B1. The operational amplifier U1 amplifies a voltage across the resistor R2 and outputs a voltage of high level to the first terminal of the electronic switch Q1. The electronic switch Q1 is turned on. Thus, the first terminal of the electronic switch Q2 is at low level. The electronic switch Q2 is turned on, turning on at least one of the switches S1-S3, and the DC voltage charges the capacitor C2. When a voltage of the first terminal of the capacitor C2 increases to a value enough to turn on the electronic switch Q3, a voltage is across the coil L1 and the dynamic type break contact K1 is off, the first terminal of the voltage transformer T1 is disconnected from the fire terminal of the AC power supply, the charge circuit stops charging the battery B1. In the embodiment, resistances of the resistors R6-R8 are different from each other. Thus, the time required for the voltage of the first terminal of the capacitor C2 to increase to a value high enough to turn on the electronic switch Q3 are different from each other when selectively turning on one of the switches S1-S3.

In the embodiment shown in the FIGURE, the electronic switch Q1 and Q3 are npn Bipolar Junction Transistors (BJTs). The electronic switch Q2 is a pnp BJT. The first terminals of the electronic switches Q1-Q3 are bases of the BJTs. The second terminals of the electronic switches Q1-Q3 are collectors of the BJTs. The third terminals of the electronic switches Q1-Q3 are emitters of the BJTs.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the appended claims should be construed to encompass all such modifications and similar arrangements.

What is claimed is:

1. A charge circuit, comprising:
a converter to convert alternating current (AC) of an AC power supply into direct current (DC) and output a DC voltage for an electronic device through a first resistor; and
a timer comprising an operational amplifier, a first electronic switch, a second electronic switch, a third electronic switch, a first switch, a second resistor, a third resistor, a fourth resistor, a fifth resistor, a first capacitor, a first diode, and a relay;
wherein the relay comprises a coil and a dynamic type break contact, the dynamic type break contact is connected between the AC power supply and the converter, the first resistor is connected between an inverting input of the operational amplifier and a non-inverting input of the operational amplifier, an output of the operational amplifier is connected to a first terminal of the first electronic switch, a second terminal of the first electronic switch is connected to the converter through the second resistor to receive the DC voltage, a third terminal of the first electronic switch is grounded, the second terminal of the first electronic switch is connected to a first terminal of the second electronic switch through the third resistor, a second terminal of the second electronic switch is connected to the converter to receive the DC voltage, a third terminal of the second electronic switch is connected to a first terminal of the fourth resistor through the first switch, a second terminal of the fourth resistor is connected to a first terminal of the third electronic switch through the fifth resistor, a second terminal of the third electronic switch is connected to the converter through the coil to receive the DC voltage, the first diode and the coil are connected in parallel, an anode of the first diode is connected to the second terminal of the third electronic switch, a cathode of the first diode is connected to the converter, a third terminal of the third electronic switch is grounded, the first and third electronic switches are turned on when the first terminals of the first and third electronic switches are at a high level, the first and third electronic switches are turned off when the first terminals of the first and third electronic switches are at a low level, the second electronic switch is turned on when the first terminal of the second electronic switch is at a low level, the second electronic switch is turned off when the first terminal of the second electronic switch is at high level, when the first switch is on and the electronic device is charged for a preset time, the third electronic switch is turned on and there is a current in the coil, and the dynamic type break contact is off.

2. The charge circuit of claim 1, wherein the converter comprises a voltage transformer, a bridge rectification circuit comprising a second diode, a third diode, a fourth diode, a fifth diode, a sixth resistor, a seventh resistor, a second capacitor, a sixth diode and a light emitting diode (LED), a first input terminal of the voltage transformer is connected to a live wire of the AC power supply through the dynamic type break contact, a second input terminal of the voltage transformer is connected to a neutral wire of the AC power supply, a cathode of the second diode is connected to an anode of the third diode, an anode of the second diode is connected to an anode of the fourth diode, a cathode of the fourth diode is connected to an anode of the fifth diode, a cathode of the third diode is connected to a cathode of the fifth diode, a first output terminal of the voltage transformer is connected to a node between the cathode of the second diode and the anode of the third diode, a node between the anode of the second diode and the anode of the fourth diode is grounded, a node between the cathode of the third diode and the anode of the fifth diode is connected to an anode of the electronic device through the sixth resistor, an anode of the sixth diode, a cathode of the sixth diode, and the first resistor in that order, the node between the cathode of the third diode and the anode of the fifth diode is grounded through the second capacitor, a cathode of the electronic device is grounded through the seventh resistor, the LED and the seventh resistor are connected in parallel, an anode of the LED is connected to the cathode of the electronic device, and a cathode of the LED is grounded.

3. The charge circuit of claim 1, wherein the timer further comprises a second switch, a third switch, an eighth resistor, and a ninth resistor, a first terminal of the second switch is connected to the third terminal of the second electronic switch, a second terminal of the second switch is connected to the first terminal of the third electronic switch through the eighth resistor and the fifth resistor in that order, a first terminal of the third switch is connected to the third terminal of the second electronic switch, and a second terminal of the third switch is connected to the first terminal of the third electronic switch through the ninth resistor and the fifth resistor, in that order.
